(19) United States
(12) Patent Application Publication
(10) Pub. No.: US 2012/0210076 A1
(43) Pub. Date: Aug. 16, 2012

(54) USER DEVICE PERFORMING DATA RETENTION OPERATION, STORAGE DEVICE AND DATA RETENTION METHOD

(75) Inventors: MI KYOUNG JANG, SEOUL (KR); DAE-KYU PARK, SEOUL (KR); DONGGI LEE, YONGIN-SI (KR)

(73) Assignee: SAMSUNG ELECTRONICS CO., LTD., SJWON-SI (KR)

(21) Appl. No.: 13/352,402

(22) Filed: Jan. 18, 2012

(30) Foreign Application Priority Data
Feb. 10, 2011 (KR) 10-2011-0012009

(51) Int. Cl. G06F 12/00

(52) U.S. Cl. 711/154; 711/E12.001

(57) ABSTRACT

Disclosed is a method of operating a data storage device. The method includes; causing the data storage device to transition from an off-line state to an on-line state, receiving a current global time as communicated from a host during the on-line state, and during the on-line state, refreshing data stored in the data storage device in response to the current global time using at least one normal data retention operation.

### CROSS-REFERENCE TO RELATED APPLICATIONS

A claim of priority under 35 U.S.C §119 is made to Korean Patent Application No. 10-2011-0012009, filed Feb. 10, 2011, the subject matter of which is hereby incorporated by reference.

### BACKGROUND

The inventive concept relates to semiconductor memory devices that are capable of performing a data retention operation in response to a global time, and more particularly, relate to a user device, a storage device and a data retention method capable of performing a data retention operation based on a global time.

Mobile electronic devices such as a digital camera, an MP3 player, a cellular phone, a tablet PC, etc. are recently used in large numbers. Such mobile electronic devices use a non-volatile memory device (e.g., a flash memory) as its data storage media. A non-volatile memory device retains stored data even at power-off and has low power and high density characteristics.

In non-volatile memory devices, a matter of grave concern is a data retention characteristic associated with the data reliability. In case of a flash memory, charges stored in a floating gate are leaked due to various causes. For example, charges are leaked from the floating gate through various fail mechanisms such as thermionic emission and charge diffusion through defective insulation film, ion impurity, the lapse of time, and so on. Charge leakage makes a threshold voltage of a memory cell be reduced. On the other hand, a threshold voltage of a memory cell may increase due to various stresses.

As a result, it is necessary to manage data stored in a memory cell without a variation according to time lapse. This data managing operation is called data retention. The data retention indicates an operation of refreshing data of a specific memory area every data retention period. That is, the data retention is defined by an operation erasing a selected memory area and rewriting data stored before erasing. It is possible to prevent the reliability from being lowered due to various causes (e.g., charge leakage) by applying the effective data retention scheme.

### SUMMARY

One embodiment the inventive concept provides a method of operating a data storage device, the method comprising; causing the data storage device to transition from an off-line state to an on-line state, receiving a current global time as communicated from a host during the on-line state, and during the on-line state, refreshing data stored in the data storage device in response to the current global time using at least one normal data retention operation.

Another embodiment of the inventive concept provides a user device comprising; a host communicating a current global time, and a data storage device configured to receive the current global time, transition from an off-line state to an on-line state, and during the on-line state refresh stored data in response to the current global time using at least one normal data retention operation.

### BRIEF DESCRIPTION OF THE DRAWINGS

The above and other objects and features will become apparent from the following description with reference to the following figures, wherein like reference numerals refer to like parts throughout the various figures unless otherwise specified, and wherein

FIG. 1 is a block diagram of a user device according to an embodiment of the inventive concept.

FIG. 2 is a diagram for describing a retention operation according to an embodiment of the inventive concept.

FIG. 3 is a diagram showing a global time providing method according to an embodiment of the inventive concept.

FIG. 4 is a diagram showing a global time providing method according to another embodiment of the inventive concept.

FIG. 5 is a block diagram of a storage device according to an embodiment of the inventive concept.

FIG. 6 is a flowchart of a retention method according to an embodiment of the inventive concept.

FIG. 7 is a timing diagram showing a retention method according to an embodiment of the inventive concept.

FIG. 8 is a timing diagram for a compensation retention operation according to an embodiment of the inventive concept.

FIG. 9 is a timing diagram for a compensation retention operation according to another exemplary embodiment of the inventive concept.

FIG. 10 is a timing diagram for a compensation retention operation according to still another embodiment of the inventive concept.

FIG. 11 is a block diagram of a solid state drive (SSD) system according to an embodiment of the inventive concept.

FIG. 12 is a block diagram of a memory card according to an embodiment of the inventive concept.

FIG. 13 is a block diagram of a memory device according to an embodiment of the inventive concept.

FIG. 14 is a block diagram of a computing system according to an embodiment of the inventive concept.

### DETAILED DESCRIPTION OF EMBODIMENTS

The inventive concept will now be described in some additional detail with reference to the accompanying drawings. The inventive concept may, however, be embodied in many different forms and should not be construed as being limited to only the illustrated embodiments. Rather, the illustrated embodiments are provided so that this disclosure will be thorough and complete, and will fully convey the scope of the inventive concept to those skilled in the art. Throughout the written description and drawings, like reference numbers and labels are used to denote like or similar elements.

It will be understood that, although the terms first, second, third etc. may be used herein to describe various elements and components, these elements, and components should not be limited by these terms. These terms are only used to distinguish one element or component from another. Thus, a first element or component discussed below could be termed a second element or component without departing from the teachings of the inventive concept.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Below, the inventive concept will be described in the context of embodiments implemented using flash memory device(s) as a non-volatile storage media. However, the inventive concept is not limited to only flash memory based embodiments. Rather, non-volatile storage media within embodiments of the inventive concept may be formed using other types of non-volatile memory devices, such as PRAM, MRAM, ReRAM, FRAM, NOR flash memory, etc.

Embodiments of the inventive concept may incorporate more than one type of semiconductor memory devices, including volatile and non-volatile memory devices.

Throughout the written description and claims that follow, the term “global time” is used. This term, “global time”, should be broadly construed to mean any agreed upon standard time designation. For example, the term “global time” includes standard time zone (longitudinal) designations (e.g., Eastern Standard Time (EST) in the United States) as well as reference time designations recognized by scientific, governmental and commercial interests (e.g., Greenwich Mean Time). In certain embodiments of the inventive concept a particular global time may be provided to a host or data storage device via a network (public and/or private), such as a satellite communications network, a wire-wireless network, the Internet, etc.

The term “data retention operation” will also be used throughout the written description and claims. A data retention operation is any functionality that, wholly or in part, contributes to the reestablishment (or redefinition) of data value(s) stored in a memory. Data retention operations may be performed asynchronously or on a scheduled basis. The memory subjected to the data retention operation may be volatile or non-volatile in general designation, and the reestablishment of previously stored data values may include, for example, functions that read, re-write (or overwrite) stored data, and/or refresh stored data. Data retention operations may be performed to compensate for drifting (varying) of stored data value(s) due to one or more causes, such as charge leakage, that occur over time. Regardless of particular mechanisms involved—that will vary with memory type—the stored data being reestablished by a data retention operation will hereafter be said to be “refreshed.”

The terms “on-line” and “off-line” will also be used throughout the written description and claims. The term “on-line” indicates an operative state for the storage device wherein it is functionally active and electrically connected to a host. In many instances, the host will “drive” (i.e., provide enabling signals to) the connected storage device when it is on-line. The term “off-line” means the opposite of “on-line” and indicates a non-operative state for the storage device wherein it is either functionally inactive or electrically isolated from the host.

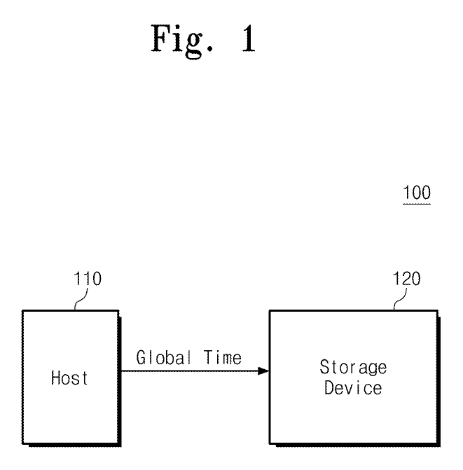

Figure (FIG. 1 is a general block diagram of a user device according to an embodiment of the inventive concept. Referring to FIG. 1, a user device 100 comprises a host 110 and a storage device 120. The storage device 120 may include non-volatile memory and/or volatile memory devices.

The host 110 may be configured to communicate a global time GT to the storage device 120. The host 110 may communicate the global time GT periodically when the storage device 120 is on-line. Alternatively, the host 110 may communicate the global time GT one-time when the storage device 120 is electrically connected to the host 110. The host 110 may include handheld electronic devices such as a personal/portable computer, a PDA, a PMP, an MP3 player, etc., an HDTV, and the like.

The storage device 120 may essentially perform two types of data retention operation in relation to designated memory areas: a normal retention operation performed during on-line periods in response to a received global time GT and a compensation (i.e., make-up) retention operation performed when the storage device enters the on-line state from an off-line state. Both types of data retention operation may be used to refresh (or update) certain meta data stored in a meta data area of the storage device 120, as well as payload data generally stored in the storage device 120.

Following receipt of the global time GT, the storage device 120 may periodically refresh stored data during an on-line period. That is, multiple normal retention operations may be sequentially performed in response to a single receipt of the global time GT. For each normal retention operation, the storage device 120 may read data stored in a selected memory area, and then rewrite the read (copied) data to the same memory area or a different memory area. Once refreshing is completed, the storage device 120 may write updated location information associated with a refreshed memory area (and possibly also indicating a refresh time) to the meta data area. A refresh time may be indicated in relation to one or more global time(s) GT. Hereafter, information indicating the location of refreshed memory area and/or information indicating a refresh time will be called “retention information”.

When first connected with the host 110, the storage device 120 may perform a power-on reset (POR) operation to transition into the on-line state. While off-line, no data retention operations have been performed for any memory area, since the storage device is in an inoperative state (i.e., lacking power or enabling control signals). Depending on the duration of the off-line period, one or more scheduled data retention operations may have been skipped. So, the storage device is essentially running behind on its routine data retention schedule. Accordingly, one or more “compensation retention operations” should be performed when the storage device 120 returns to an on-line state.

The storage device 120 may use retention information stored in the meta area to perform necessary compensation retention operation(s). From the retention information, the storage device 120 may determine (1) a duration of the latest off-line period; and (2) one or more memory areas that should have been refreshed during the off-line period. These determination may be made, for example, in view of a last received global time GT prior to the latest off-line period, a first received global time GT received during the current on-line period, a last refreshed memory area, and a next memory area to be refreshed according to a given memory area order or data retention operation schedule. In this manner, the storage device 120 may perform one or more compensation retention operation(s) on sequentially identified memory area(s) on this basis of the foregoing determinations.

According to certain embodiments of the inventive concept, the storage device 120 may accurately calculate the duration of a latest off-line period in relation to (e.g.,) multiple received global times, a data retention operation schedule and a last performed data retention operation. Thus, even when confronted with relatively extensive off-line periods, the storage device 120 may nonetheless faithfully track and perform data retention operations associated with all memory areas of the storage device 120. That is, a combination of on-line normal retention operations and compensation retention operations following off-line periods may be used to continuously manage and refresh data stored in the constituent memory.

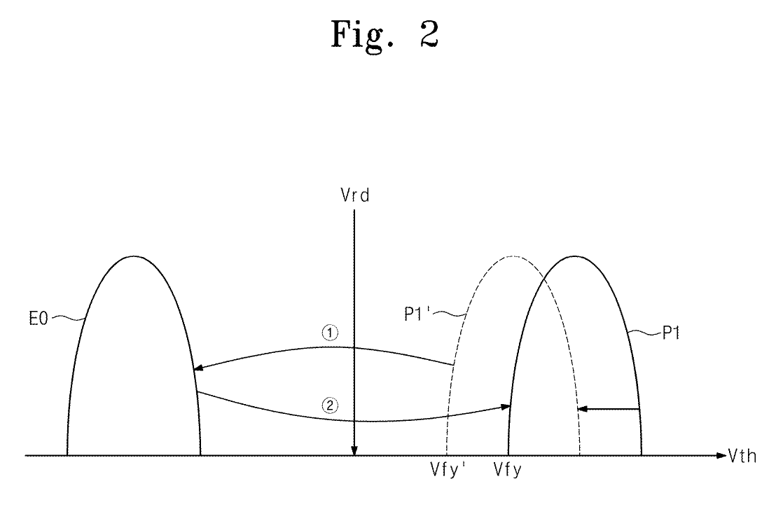

FIG. 2 is a conceptual diagram describing a data retention operation according to an embodiment of the inventive concept. As a time passes, the threshold voltage of a previously programmed flash memory cell may drift lower (from P1 to P1′) due to various causes such as charge leakage, fabrication defects, and the like. At some point, the programmed threshold voltage may drift near or below a given read voltage Vrd that is used to discriminate between an erase state EU and the programmed state P1. Such impairment in the read margin between defined memory cell states tends to increase read errors and degrade data integrity. Accordingly, a data retention operation should be periodically performed to remedy unwanted drift in memory cell threshold voltages.

Assuming that the memory cells are not directly over-writeable, the memory cells of a memory area identified by a data retention operation may be erased (\textcircled{1}), and then rewritten to the erased memory area (\textcircled{2}). As a result, the memory cells of FIG. 2 having been previously programmed to the program state P1 may be erased during the data retention operation to have the erase state E0, and afterwards, the erased memory cells may be reprogrammed to have the program state P1.

The foregoing example of a data retention operation is presented under an assumption that a flash memory device is being used. But, the inventive concept is not limited to only flash memory devices. Other embodiments of the inventive concept will use different types of memory devices, such as those programmed by resistance/threshold voltage shifts. Directly over-writable memory cells may be subjected to a data retention operation that does not require an erase procedure. Error detection and correction may be additionally performed to increase the reliability of the data retention operation.

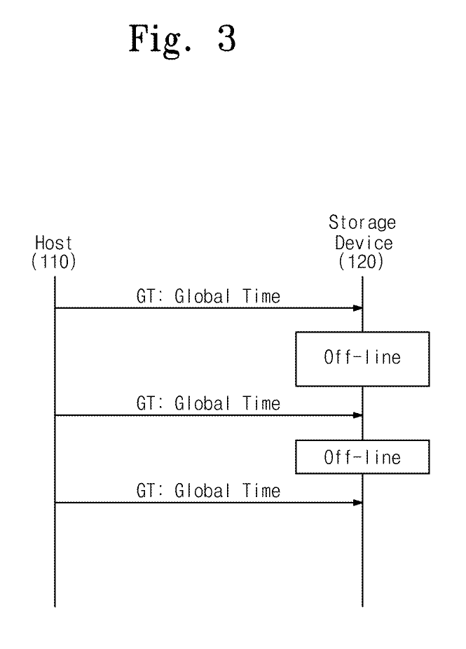

FIG. 3 is a conceptual diagram further illustrating the provision of global time GT using a method according to an embodiment of the inventive concept. Referring to FIG. 3, each time the host 110 is connected to the storage device 120, the host 110 communicates a global time GT to the storage device one-time.

Upon receiving this one-time global time GT indication, the storage device 120 may nonetheless continuously track and account for scheduled data retention operations using an internally generated refresh clock (e.g., a counter maintaining a counted, internal refresh clock) that runs during the on-line period. The storage device 120 may perform one or more normal retention operation(s) while on-line. Whenever a normal retention operation is executed, the storage device 120 may update location information for a refreshed memory area and a corresponding refresh time.

However, once the storage device 120 goes off-line due to disconnection from the host 110, for example, the periodic data retention operations will cease. Then, when the storage device 120 is re-connected to the host 110, the host 110 may detect said connection and communicate a “current” global time GT to the storage device 120. The host 110 may, for example, determine the connected/disconnected status of the storage device 120 using conventionally understood plug and play functionality.

Thus, an operatively connected storage device 120 will receive one or more global times GT from the host 110 during the on-line period. At least a most recently received (i.e., a next:current”) global time GT may be stored by the storage device 120 during on-line periods. Further, so long as the storage device 120 remains on-line, one or more normal retention operations may be performed in response to at least one received global time GT.

Upon transitioning from an off-line to an on-line state, the storage device 120 will calculate (e.g., estimate) the duration of the latest off-line period. This calculation may be made, for example, with reference to the current global time GT (GT1) and a last received global time (GT2) from a previous on-line session. The calculated off-line duration may then be used to identify skipped data retention operations, identify memory areas requiring refresh as the result of the off-line period, and perform corresponding compensation retention operations.

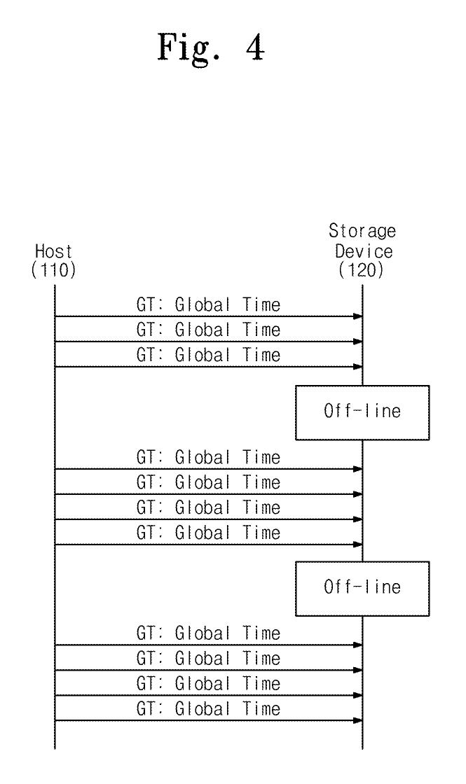

FIG. 4 is a conceptual diagram further illustrating the provision of global time GT using a method according to another embodiment of the inventive concept. Referring to FIG. 4, each time the host 110 is connected to the storage device 120, the global time GT is periodically communicated from the host 110 to the storage device 120 during the on-line period.

That is, the host 110 may detect an on-line state for the storage device 120 and periodically communicate the global time GT to the storage device 120. The storage device 120 may perform data retention operation(s) in response to the periodically provided global time GT. The storage device 120 may record refresh times corresponding to each data retention operation (e.g.,) in terms of one or more global times GT. Accordingly, the storage device 110 will not require a separate counter or similar circuits to generate an internal refresh clock. Rather, all data retention operations may be performed synchronously with a received global time GT. As before, whenever a data retention operation is performed, the storage device 120 may store location information for a refreshed memory area and a corresponding refresh time in terms of a received global time GT.

Thus, the host 110 may repeatedly communicate the global time GT to the storage device 120 during an on-line state. As before, an on-line state for the storage device 120 may be detected by the host 110 using conventionally understood plug and play techniques.

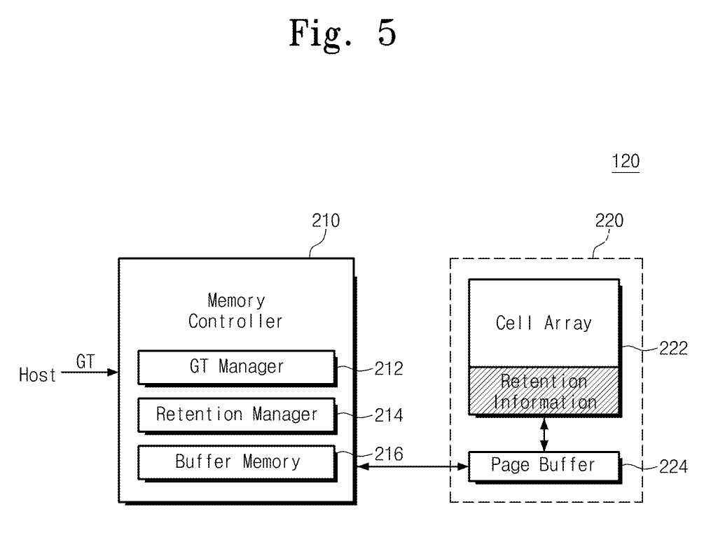

FIG. 5 is a block diagram of a storage device according to an embodiment of the inventive concept. Referring to FIG. 5, a storage device 120 generally comprises a memory controller 210 and a flash memory device 220.

The memory controller 210 may interface with a host 110 in FIG. 1 and the flash memory device 220. In response to a write command of the host 110, the memory controller 210 may control the flash memory device 220 such that data provided from the host 110 is written in the flash memory device 220. Further, the memory controller 210 may control a read operation of the flash memory device 220 in response to a read command from the host 110.

The memory controller 210 may perform a data retention operation based on a global time GT provided from the host 110. The global time GT may be provided periodically. In the event that the global time GT is provided periodically, the memory controller 210 may record at least a most recently received global time GT, and each data retention operation may be identified in relation to a received global time. For example, the memory controller 210 may store location information for a memory area refreshed by a data retention operation. As described above, retention information may include at least one global time as well as location information for the memory area being refreshed. The retention information may be updated in a meta data area of the flash memory device 220 during each data retention operation.

On the other hand, in the event that the global time GT is provided one-time when the storage device 120 transitions from off-line to on-line, the memory controller 210 may generate (e.g., count) an internal refresh time based on a received global time GT. Whenever a data retention operation is executed, the memory controller 210 may generate and update retention information based on the internal refresh time as derived from a received global time GT.

To provide the above-described functionality, the memory controller 210 may include a global time (GT) manager 212, a retention manager 214, and a buffer memory 216. The GT manager 212 may provide the global time GT provided from the host 110 as time information initiating a data retention operation. If the global time GT is provided periodically from the host 110, the GT manager 212 may update the global time GT periodically. The GT manager 212 may also provide an updated global time GT as retention information whenever the data retention operation is performed.

On the other hand, in the event that the global time is provided one-time upon transition of the storage device 120 to the on-line state, the GT manager 212 may begin generation (e.g., counting) of an internal refresh time upon receipt of the global time GT. The internal refresh time, as counted during the on-line state, may be maintained as an updated global time GT, and the internal refresh time may be provided as part of the retention information associated with a data retention operation.

The retention manager 214 may perform a data retention operation where data stored in the flash memory device 220 is periodically refreshed. In particular, the retention manager 214 may store the global time GT provided from the global time manager 212 as time information at the data retention operation. If the storage device 120 transitions to on-line from off-line, the retention manager 214 may estimate an off-line period duration based on a current global time (GT1) received the on-line period and a last received global time (GT2) stored during the last on-line period before the most recent off-line period. The retention manager 214 may also determine a next memory area (or a sequence of next memory areas) to be refreshed by data retention operation(s) upon entering an on-line state.

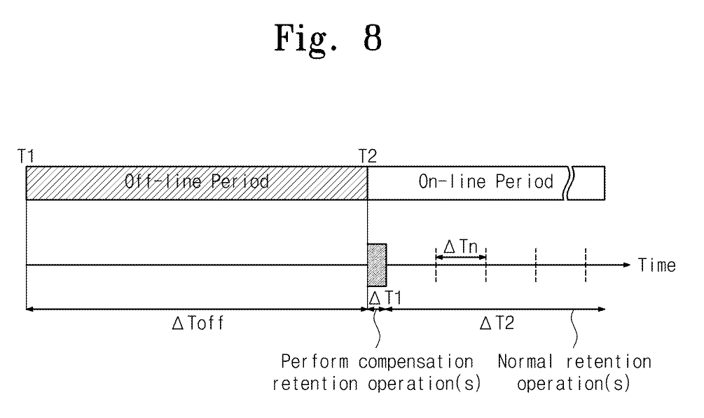

That is, the retention manager 214 may perform certain compensation retention operations for the next memory area(s). Each compensation retention operation may be performed in such a manner that it emulates a normal data retention operation. Alternatively, a compensation retention operation may be performed with different timing and/or in relation to a differently sized memory area than the normal retention operation. One possible compensation retention operation will be more fully described with reference to FIGS. 8, 9 and 10.

The buffer memory 214 may be used to temporarily store data retrieved from the flash memory device during a data retention operation. If the data retention operation is executed on a memory block by memory block basis (i.e., in accordance with a minimum erase unit for the flash memory device 220), the size of the buffer memory 216 should be at least greater than a memory block. If data from a particular memory block (i.e., a retention target) is stored in the buffer memory 216, the memory controller 210 may perform an erase operation on the retention target. Once the erase operation is complete, data temporarily stored in the buffer memory 216 may be rewritten to the (now erased) retention target. In this regard, the address of the retention target and a corresponding global time may be stored in the meta data area as retention information.

The memory controller 210 may be used to calculate the duration of an off-line period based on, at least in part, on a current global time GT received from the host 110 when the storage device 120 transitions from an off-line to an on-line state. Once the duration of the off-line period is calculated, information may be extracted or derived identifying a last refreshed memory area and/or a next memory area to be refreshed using, for example, certain data retention information stored with other meta data describing data characteristics. Accordingly, the memory controller 210 may perform a data retention operation for the next memory area. In this manner, a data retention operation performed during the on-line period may be directed to an appropriately identified “next memory area” of the flash memory device 220.

The flash memory device 220 may be provided as storage media within the storage device 120 in certain embodiments of the inventive concept. The flash memory device 220 may include a cell array 222 and a page buffer 224. The cell array 222 may include a plurality of memory blocks. Each memory block may be formed of a plurality of pages. The memory block may become a minimum erase unit of the flash memory device 220. Accordingly, the data retention operations may be made performed on a memory block by memory block basis. The cell array 222 typically includes a meta data area that may be used to store updated retention information whenever the data retention operation is performed. The retention information may include a data retention operation history expressed (e.g.,) in terms of one or more global times GT, addresses for particular memory areas, etc.

The flash memory device 220 may be formed of a NAND flash memory having a large capacity. Alternatively, the flash memory device 220 may be formed of a next-generation non-volatile memory such as a PRAM, an MRAM, a ReRAM, a FRAM, etc. or a NOR flash memory. The data retention unit may be a memory block. But, the inventive concept is not limited to this disclosure. The data retention unit may be set variously according to memory types and characteristics.

As above described, the storage device 120 may perform a normal retention operation(s) based on a global time GT received from the host 110 during on-line periods, and may additionally perform necessary compensation retention operation(s) following off-line periods. Accordingly, it is possible to efficiently maintain a data retention operation schedule that systematically refreshes a constituent memory on a memory area by memory area basis.

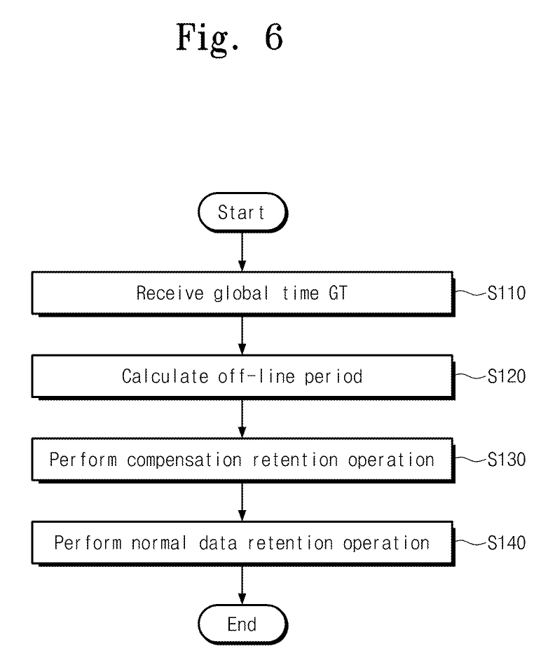

FIG. 6 is a flowchart summarizing a data retention method according to an embodiment of the inventive concept. The exemplary approach to data retention operations will be described under an assumption that the storage device 120 has just transitioned from an off-line to an on-line state.

When the storage device 120 is connected to the host 110 and transitions from the off-line to the on-line state, the storage device 120 receives the global time GT from the host 110 (S110). For example, the storage device 120 may receive the global time GT from the host 110 via the global time manager 212 described in relation to FIG. 5.

Next, the global time manager 212 may be used to calculate an off-line period for the storage device 120 based on the received global time GT and stored retention information (S120). For example, the retention information may include information indicating a last received global time (GT2) that was received prior to a current global time GT (GT1). The global time manager 212 may calculate the off-line period by comparing the first global time GT1 with the second global time GT2.

Once the duration of the off-line period is calculated, there may be generated information certain compensation retention operations which have not been performed by the storage device during the off-line period. Typically, specific memory blocks may be identified in relation to the skipped data retention operations according to an data retention operation schedule, a refresh address order, and/or a programming order. Accordingly, once the duration of the off-line period has been calculated, information regarding which memory blocks have been (or have not been) subjected to a timely data retention operation may be derived in relation to the calculated off-line period.

The storage device 120 may now perform certain compensation retention operation(s) directed to memory areas that were not subjected to a timely data retention operation as the result of the off-line period (S130). For example, the compensation retention operation(s) may performed upon transition of the storage device 120 from the off-line to the on-line state. Multiple compensation retention operations may be directed to respective retention targets either simultaneously or in sequence. Alternately, or additionally, multiple compensation retention operations may be performed during an on-line period in view of overall resource availability and operating expectations for the storage device 120.

Certain compensation retention methods will be more fully described hereafter with reference to FIGS. 8, 9 and 10.

The storage device 120 will also begin performing (normal) data retention operations following (or in between) any compensation retention operation(s) (S140). The normal retention operations may be performed according to an established schedule, a particular memory area order, in view of certain memory areas used to store a particular type of data, etc.

As noted above, each data retention operation may include reading data from a selected memory block, storing the read data in a buffer memory, erasing the selected memory block, and rewriting data temporarily stored in the buffer memory to the erased memory block. The data retention operation may further include storing updated retention information in a meta area. The retention information may include an address for a memory block subjected to the data retention operation as well as a corresponding global time.

Using this type of retention method consistent with embodiments of the inventive concept, the storage device 120 may perform scheduled or necessary compensation retention operation(s) that were not performed during an off-lie period. Accordingly, it is possible to maintain highly reliable stored data even in presence of relatively long off-line periods.

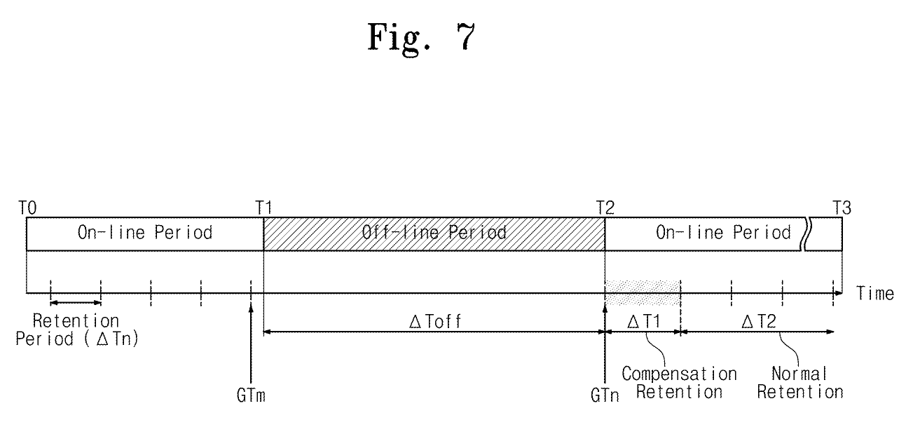

FIG. 7 is a timing diagram further illustrating a method of performing data retention operations according to an embodiment of the inventive concept.

Referring to FIG. 7, a first on-line period extends from T0 to T1 wherein the host 110 of FIG. 1 is electrically connected with the storage device 120. During the first on-line state, the storage device 120 periodically performs a data retention operation according to a retention period ΔTn. A last received global time (GTm) is received during the first on-line period, and then at time T1 the storage device 120 transitions from the first on-line state to an off-line state.

The storage device remains in the off-line state between T1 and T2 when the storage device 120 is electrically isolated from the host 110. The duration of the off-line period is ΔToff. Then, at time T2, the storage device 120 is again electrically connected with the host 110. About this time, a current global time (GTn) is received from the host 110 by the storage device 120.

The storage device 120 may calculate (or estimate) the duration of the off-line period ΔToff in view of the current global time (GTn) and the last received global time (GTm) stored during the first on-line state. In view of the calculated duration of the off-line period ΔToff, the storage device 120 may execute one or more compensation retention operations during (e.g.,) an initial period ΔT1. Following the initial period ΔT1 in which the compensation retention operations are performed, normal data retention operations may be resumed ΔT2.

FIG. 8 is another timing diagram illustrating an approach to performing data retention operations according to an embodiment of the inventive concept. Referring to FIG. 8, upon transitioning to an on-line state from an off-line state, the storage device 120 may perform one or more compensation retention operations skipped or omitted during the preceding off-line period.

Assuming that the storage device 120 is initially not connected to the host 110 during an off-line period ΔToff, at time T2 the storage device 120 is connected with the host 110. Soon thereafter, the storage device 120 receives a current global time GTn communicated from the host 110. In response, the storage device 120 reads retention information stored in a meta area during the last on-line period prior to the off-line period.

For example, the storage device 120 may extract information indicating a last received global time GTm from the retention information. The storage device 120 may also estimate a duration of the off-line period using, for example, the current global time GTn and the last received global time GTm, and then determine certain memory areas not subjected to a data retention operation during the off-line period. During a compensation retention operation period ΔT1, the storage device 120 may perform any compensation retention operation(s) not executed during the off-line period. In the illustrated embodiment of FIG. 8, it is assumed that multiple compensation retention operations may be simultaneously performed. Once the compensation retention operations are performed during the compensation retention period ΔT1, the storage device 120 performs normal retention operations during the on-line period.

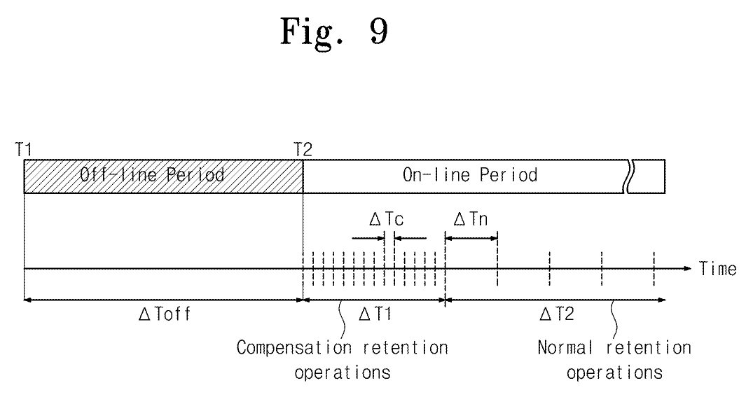

FIG. 9 is another timing diagram illustrating an approach to performing data retention operations according to an embodiment of the inventive concept. Referring to FIG. 9, the storage device 120 transitions from an off-line state to an on-line state at time T2, whereupon the storage device 120 receives a current global time GTn. Here however, the compensation retention period ΔT1 includes a defined sequence of lesser periods ΔTc during which respective compensation retention operations may be performed. The sequence of lesser periods ΔTc may have the same duration, or may have different durations determined in accordance the particular memory area being subjected to the respective compensation retention operation. Following the compensation retention period ΔT1, normal retention operations may be performed.

Thus, the illustrated embodiment of FIG. 9 assumes that multiple compensation retention operations will be sequentially performed. Of further note, the duration of the compensation retention period ΔT1 will vary in relation to the duration of the preceding off-line period, and therefore, the number of skipped data retention operations. Otherwise, the storage device 120 may operate as previously described in relation to FIG. 8.

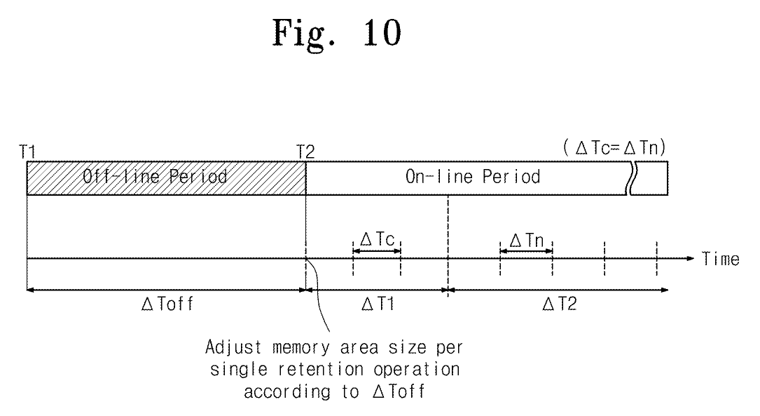

FIG. 10 is another timing diagram illustrating an approach to performing data retention operations according to an embodiment of the inventive concept. Referring to FIG. 10, when the storage device 120 transitions from the off-line to the on-line state, the storage device 120 may dynamically determine the nature and duration of the compensation retention period ΔT1 in response to the duration of the off-line period. The nature and duration of the compensation retention period ΔT1, including any defined lesser periods ΔTc, may be defined by the (e.g.,) the size and/or data composition of the memory areas not subjected to a data retention operation during the off-line period.

Again it is assumed that the storage device 120 is initially not connected to the host 110 during the off-line period ΔToff. At time T2, the storage device 120 is connected and soon thereafter receives a current global time GTn from the host 110. The storage device 120 may then read retention information from a meta area stored during the preceding on-line state. The storage device 120 may then extract information regarding the last received global time GTm. The storage device 120 may then calculate (or estimate) the duration of the off-line period using the current global time GTn and the last global time GTm. The calculated duration of the off-line state may then be used to determine the size (cumulatively or separately) of memory area (s0 not subjected to a data retention operation as the result of the off-line period.

For example, the storage device 120 may determine an amount of data that must be refreshed during one or more compensation retention operation(s) to be performed during the compensation retention period ΔT1 based on the size of the memory area(s) associated with the compensation retention operations. If the duration of the off-line period ΔToff is relatively long, the size of the implicated memory area(s) will be relatively large. Using such information, the length of the compensation retention period ΔT1 may be extended, or the size of each memory area refreshed by each compensation retention operation may be increased. All or some of the lesser periods ΔTc within the compensation retention period ΔT1 may be altered dynamically given existing constraints, such as compensation retention period ΔTn associated with a normal data retention operation.

On the other hand, if the off-line period ΔToff is relatively short, the size of a memory area associated with a compensation retention operation may be decreases. In this case, the amount of data being refreshed by any given compensation retention operation may be decreased. Likewise, respective lesser periods ΔTc for all or some of the compensation retention operations may be altered and reduced in duration, or made identical to a normal retention period ΔTn.

Thus, within certain embodiments of the inventive concept, the number, operative nature, duration and mode of execution (simultaneous or sequential) for compensation retention operations to be performed following an off-line period may be intelligently varied in view of (e.g.,) the duration of the off-line period and the current demands placed on storage device operating resources.

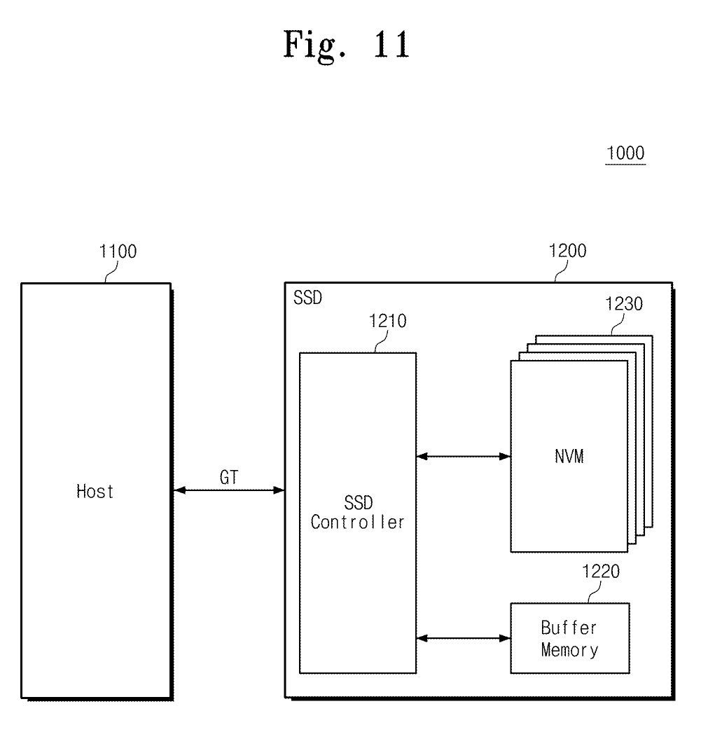

FIG. 11 is a block diagram of a solid state drive (SSD) system according to an exemplary embodiment of the inventive concept. Referring to FIG. 11, an SSD system 1000 may include a host 1100 and an SSD 1200. The SSD 1200 may include an SSD controller 1210, a buffer memory 1220, and a non-volatile memory device 1230.

The SSD controller 1210 may provide physical interconnection with the host 1100 and the SSD 1200. That is, the SSD controller 1210 may provide an interface with the SSD 1200 corresponding to a bus format of the host 1100. In particular, the SSD controller 1210 may decode a command provided from the host 1100. The SSD controller 1210 may access the non-volatile memory device 1230 according to a decoding result. The bus format of the host 1110 may include a Universal Serial Bus (USB), a Small Computer System Interface (SCSI), a PCI express, an ATA, a Parallel ATA (PATA), a Serial ATA (SATA), a Serial Attached SCSI (SAS), or the like.

The SSD controller 1210 may perform a compensation retention operation based on a global time GT provided from the host 1100. The SSD controller 1210 may read a memory area of the non-volatile memory device 1230 periodically at an on-line state and store it in the buffer memory 1220. The SSD controller 1210 may erase the memory area to rewrite the data stored in the buffer memory 1220 to the erased memory area. In particular, at a point of time when the SSD 1200 is switched to an on-line state from an off-line state, the SSD controller 1210 may calculate an off-line period according to the global time GT and perform a compensation retention operation according to the calculated off-line period. It is possible to improve the reliability of data stored in the non-volatile memory device 1230 according to the compensation retention operation.

The buffer memory 1220 may be used to temporarily store write data provided from the host 1100 or data read out from the no-volatile memory device 1230. If data existing in the non-volatile memory device 1230 is stored in the buffer memory 1220 at a read request of the host 1100, the buffer memory 1220 may support a cache function of directly providing the stored (or, cached) data to the host 1100 without accessing to the non-volatile memory device 1230. Typically, a data transfer speed of a bus format (e.g., SATA or SAS) of the host 1100 may be more rapid than that of a memory channel of the SSD 1200. That is, in the event that an interface speed of the host 1100 is remarkably high, lowering of the performance due to a speed difference may be minimized by providing a large-capacity buffer memory 1220.

The buffer memory 1220 may be formed of a synchronous DRAM to provide sufficient buffering to the SSD 1200 used as an auxiliary mass storage device. But, it is well understood that the buffer memory 1220 is not limited to this disclosure.

The non-volatile memory device 1230 may be provided as a storage media of the SSD 1200. For example, the non-volatile memory device 1230 may be formed of a NAND flash memory having a mass storage capacity. The non-volatile memory device 1230 may be formed of a plurality of memory devices. In this case, the plurality of memory devices may be connected with the SSD controller 1210 by the channel. There is exemplarily described an example that the non-volatile memory device 1230 is formed of a NAND flash memory as a storage media. But, the non-volatile memory device 1230 may be formed of other non-volatile memory devices. For example, the storage media may be formed of a NOR flash memory, a PRAM, an MRAM, a ReRAM, a FRAM, or the like. The inventive concept may be applied to a memory system that other memory devices are used together. The storage media can be formed of a volatile memory device (e.g., DRAM).

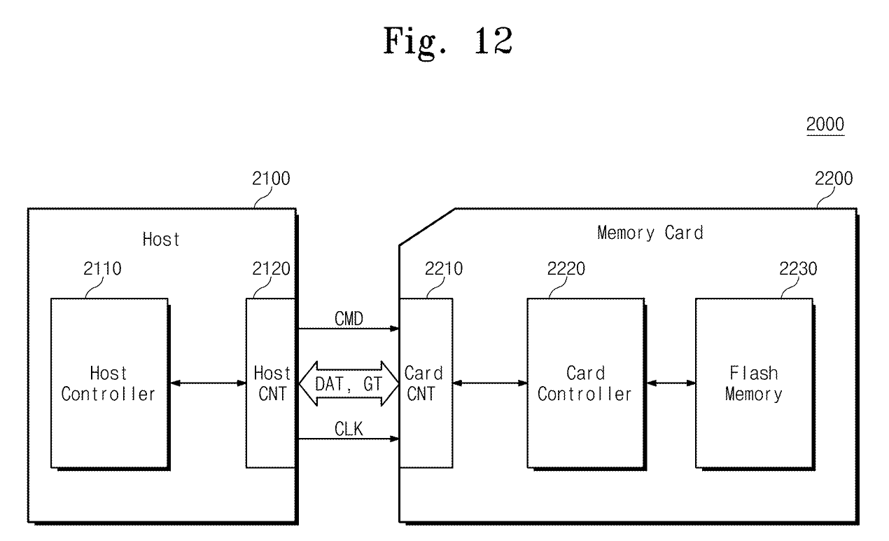

FIG. 12 is a block diagram of a memory card according to an exemplary embodiment of the inventive concept. Referring to FIG. 12, a memory card system 2000 may include a host 2100 and a memory card 2200. The host 2100 may include a host controller 2110 and a host connection unit 2120. The memory card 2200 may include a card connection unit 2210, a card controller 2220, and a flash memory 2230.

The host connection unit 2120 and the card connection unit 2210 may be formed of a plurality of pins, which include a command pin, a data pin, a clock pin, a power pin, and so on. The number of the plurality of pins may differentiate according to a card type. For example, an SD card may include eight pins.

The host 2100 may write data in the memory card 2200 or read data from the memory card 2200. The host controller 2110 may transfer a command (e.g., a write command) a clock signal CLK generated by a clock generator (not shown) within the host 2100, and data to the memory card 2200 via the host connection unit 2120. In particular, the host 2100 may provide a global time GT periodically or at an initial point of time when the memory card 2200 is switched to an on-line state.

The card controller 2220 may respond a write command received via the card connection unit 2210 to store data in the flash memory 2230 in synchronization with a clock signal generated by a clock generator (not shown) within the card controller 2220. The flash memory 2230 may store data transferred from the host 2100. For example, the flash memory 2230 may store image data transferred from the host 2100 being a digital camera.

The card controller 2220 may perform a compensation retention operation based on a global time GT provided from the host 2100. The card controller 2220 may periodically perform a retention operation on memory areas of the flash memory device 2230 at an on-line state. When switched to the on-line state from the off-line state, the card controller 2220 may calculate an off-line period based on the global time GT and perform a compensation retention operation according to the calculated off-line period. It is possible to improve the reliability of data stored in the flash memory device 2230 according to the compensation retention operation.

The card connection unit 2210 may be configured to communicate with the host 2100 via one of various interface protocols such as USB, MMC, PCI-E, SAS, SATA, PATA, SCSI, ESDI, IDE, and the like.

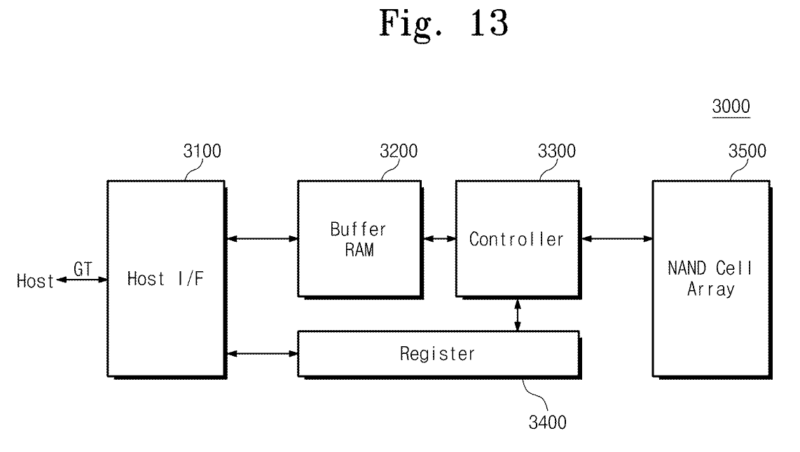

FIG. 13 is a block diagram of a memory device according to an exemplary embodiment of the inventive concept. For example, the inventive concept may be applied to a fusion One-NAND® flash memory device which performs a global time based retention operation. Referring to FIG. 13, a host may provide a global time GT to the fusion memory device 3000 according to an exemplary embodiment of the inventive concept. The fusion memory device 3000 may compensate for a retention operation, which is not performed at an off-line period, based on the global time.

The fusion memory device 3000 may include a host interface 3100 for exchanging various information with a device using different protocols; a buffer RAM 3200 for storing codes of driving a memory device or temporarily storing data; a controller 3300 for controlling reading, programming and all states in response to a control signal and a command provided from the external; a register 3400 for storing data such as configuration for setting a system operating environment within the memory device; and a NAND cell array 3500 formed of non-volatile memory cells and a page buffer.

The controller 3300 may perform a compensation retention operation based on a global time GT provided from the host. The controller 3300 may periodically perform a retention operation on memory areas of the NAND cell array 3500 at an on-line state. When switched to the on-line state from the off-line state, the controller 3300 may calculate an off-line period based on the global time GT and perform a compensation retention operation according to the calculated off-line period. It is possible to improve the reliability of data stored in the NAND cell array 3500 according to the compensation retention operation.

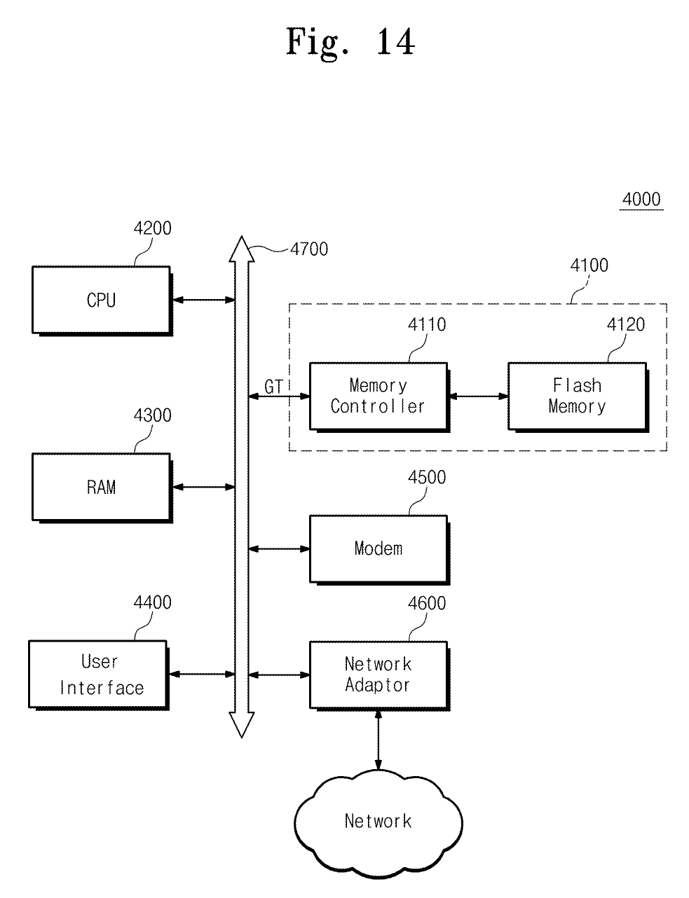

FIG. 14 is a block diagram of a computing system according to an exemplary embodiment of the inventive concept. A computing system 4000 may include a memory system 4100, a CPU 4200, a RAM 4300, a user interface 4400, a modem 4500 such as a baseband chipset, and a network adaptor 4600 which are electrically connected with a system bus 470. The memory system 4100 may be configured the same as that illustrated in FIGS. 11, 12, and 13. In the event that the computing system 4000 is a mobile device, it may further include a battery (not shown) for supplying an operating voltage to the computing system 4000. Although not shown in FIG. 14, the computing system 4000 may further include an application chipset, a camera image processor (CIS), a mobile DRAM, and the like. The memory system 4100 may be formed of a solid state drive (SSD) which uses a non-volatile memory to store data, for example.

The memory controller 4110 may perform a compensation retention operation based on a global time GT provided via the network adaptor 4600. The memory controller 4110 may periodically perform a retention operation on memory areas of the flash memory device 4120 at an on-line state. When switched to the on-line state from the off-line state, the memory controller 4110 may calculate an off-line period based on the global time GT and perform a compensation retention operation according to the calculated off-line period. It is possible to improve the reliability of data stored in the flash memory device 4120 according to the compensation retention operation.

A non-volatile memory device and/or a memory controller according to an exemplary embodiment of the inventive concept may be packed by various packages such as PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like.

With the above description, it is possible to improve the efficiency of data retention of a storage device including a non-volatile memory device. Further, it is possible to improve the reliability of the storage device by performing a data retention operation considering an off-line period.

The above-disclosed subject matter is to be considered illustrative, and not restrictive, and the appended claims are intended to cover all such modifications, enhancements, and other embodiments, which fall within the scope of the inventive concept. Thus, to the maximum extent allowed by law, the scope is to be determined by the broadest permissible interpretation of the following claims and their equivalents, and shall not be restricted or limited by the foregoing detailed description.

What is claimed is:

1. A method of operating a data storage device, the method comprising:
causing the data storage device to transition from an off-line state to an on-line state;
receiving a current global time as communicated from a host during the on-line state; and
during the on-line state, refreshing data stored in the data storage device in response to the current global time using at least one normal data retention operation.

2. The method of claim 1, wherein the current global time is received by the data storage device one-time during the on-line state.

3. The method of claim 2, wherein refreshing the data stored in the data storage device comprises performing a plurality of normal data retention operations.

4. The method of claim 3, wherein each one of the plurality of normal data retention operations is performed in response to an internal refresh clock derived from the current global time.

5. The method of claim 4, wherein respectively performing each one of the plurality of normal data retention operations includes updating retention information associated with a corresponding memory area.

6. The method of claim 5, wherein the retention information includes location information identifying the corresponding memory area and refresh time information.

7. The method of claim 1, further comprising:
receiving a last global time during a previous on-line state preceding the off-line state; and
calculating a duration for the off-line state using the current global time and the last global time.

8. The method of claim 7, further comprising:
determining at least one skipped memory area not subjected to a normal data retention operation due to the off-line state in view of the duration of the off-line state; and
before refreshing the data stored in the data storage device in response to the current global time, performing at least one compensation retention operation to refresh data stored in the at least one skipped memory area.

9. The method of claim 8, wherein the at least one compensation retention operation includes a plurality of compensation retention operations respectively associated with a plurality of skipped memory areas.

10. The method of claim 9, wherein the plurality of compensation retention operations are simultaneously performed before refreshing the data stored in the data storage device in response to the current global time.

11. The method of claim 9, wherein the plurality of compensation retention operations are sequentially performed before refreshing the data stored in the data storage device in response to the current global time.

12. The method of claim 1, wherein the current global time is received by the storage device a number of times during the on-line state.

13. The method of claim 12, wherein refreshing the data stored in the data storage device comprises performing a plurality of normal data retention operations, each normal data retention operation being performed in response to a corresponding one of the number of global times received during the on-line state.

14. The method of claim 1, wherein the storage device transitions from the off-line state to an on-line state upon being electrically connected to the host.

15. A user device comprising:
a host communicating a current global time; and
a data storage device configured to receive the current global time, transition from an off-line state to an on-line state, and during the on-line state refresh stored data in response to the current global time using at least one normal data retention operation.

16. The user device of claim 15, wherein the host communicates the current global time to the data storage device one-time during the on-line state.

17. The user device of claim 15, wherein the host communicates the current global time to the data storage device a number of times during the on-line state.

18. The user device of claim 15, wherein upon refreshing the stored data, the data storage device is further configured to update a meta data area with retention information including location information for the refreshed data and a corresponding refresh time.

19. The user device of claim 15, wherein the data storage device is further configured to receive a last global time during a previous on-line state preceding the off-line state, stores information identifying the last global time, and calculate a duration for the off-line state using the current global time and the last global time.

20. The user device of claim 19, wherein the data storage device is further configured to determine at least one skipped memory area not subjected to a normal data retention operation due to the off-line state in view of the duration of the off-line state, and during a compensation retention period before refreshing the stored data, performing at least one compensation retention operation that refreshes data stored in the at least one skipped memory area.

21. The user device of claim 20, wherein the compensation retention period varies in duration according to a size of the at least one skipped memory area.

22. The user device of claim 15 wherein the host is configured to power the data storage device when the data storage device is connected to the host, and the data storage device transitions from the off-line state to the on-line state upon being connected to the host.
